(19) United States
(12) Patent Application Publication
(10) Pub. No.: US 2004/0181955 A1
(43) Pub. Date: Sep. 23, 2004

(54) Handrail guide

(76) Inventor: Harold W. Sargent, Springfield, VT (US)

Correspondence Address: Harold W. Sargent, P.O. Box 37, Springfield, VT, 05156, US

(21) Appl. No.: 10/390,498

(22) Filed: Mar. 17, 2003

(51) Int. Cl. B43L 7/10

(52) U.S. Cl. 33/473

(57) ABSTRACT

The Slotted Foot is placed across the leading edge of two stair treads. Then the Main Body is placed in a plumb position as indicated by the Plumb Vial. At this time the Wing Nut is tightened. This secures the Main Body to the Slotted Foot. Using a pencil or other marking instrument the height of the handrail or the handrail bracket can now be marked thru the one-eighth inch holes in the Main Body.

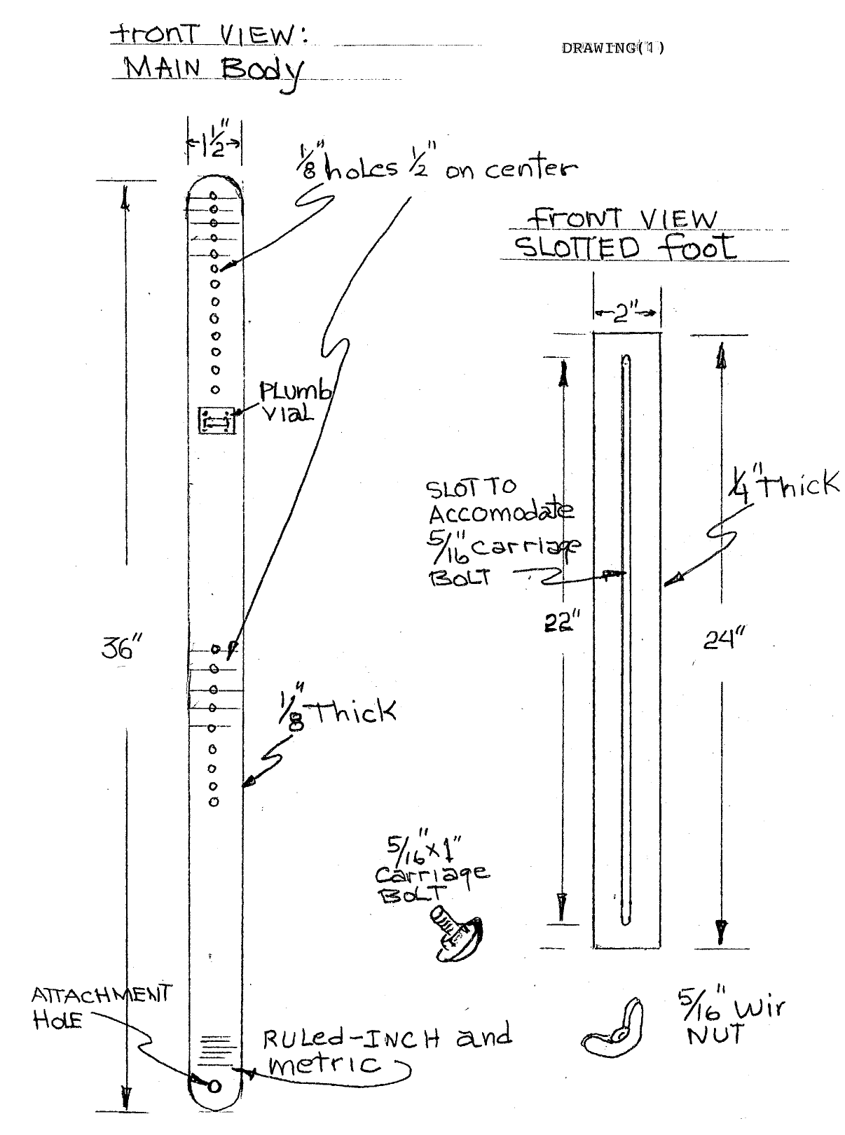

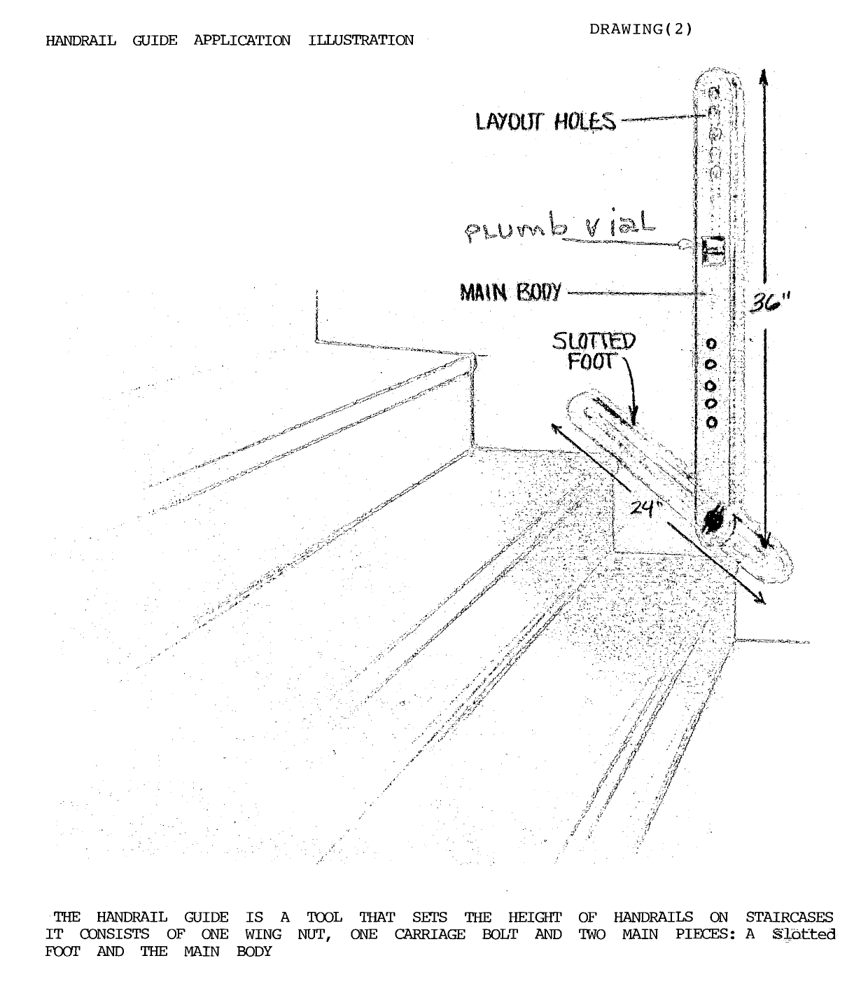

### BACKGROUND OF THE INVENTION

Harold Sargent, inventor of the Handrail Guide tool, was inspired to develop the idea for the Handrail Guide when he wanted to create a unit that would comply with the building codes in Massachusetts and other states that require handrails on staircases to be placed at a specific height. He created a prototype of his product. (photo enclosed in application)

### HANDRAIL GUIDE PARTS DESCRIPTION

The Handrail Guide consists of a slotted foot; twenty four inches long by two inches wide by one quarter inch thick with a slot that begins one inch in from one end and continues to within one inch of the opposite end. The width of the slot will be determined by its ability to accommodate a five sixteenths carriage bolt.

A Main Body is thirty-six inches long by one and one half inches wide by one-eighth inch thick to be ruled in inches and metric with pre drilled one-eighth inch holes at one-half inch intervals from the twelve inch mark to the sixteen inch mark and from the twenty-four inch mark then to the thirty-five and one-half inch mark. At the twenty-eight inch mark, a plumb vial is attached as an indicator to show when the main body is perfectly plumb.

A five-sixteenth by one inch carriage bolt. A five-sixteenth wing nut. Footnote: The Main Body, Slotted Foot, and Thumb Screw can be made of aluminum, steel, plastic or composite materials.

What is claimed and desired to be protected by the Patent and Trademark office of the U.S. is as follows:

1. The hand rail guide eliminates the need for individuals to calculate the proper height of handrails:
The Handrail guide automatically takes into account the rise and run of a staircase.
The Handrail Guide assures compliance with state building codes.
The handrail Guide saves time on the job.
The Handrail Guide will clearly be of value to carpenter's, developer's, contractor's and do-it-yourselfers.
The Handrail Guide will allow building inspectors to quickly check for proper handrail height.
